(19) United States
(12) Patent Application Publication
(10) Pub. No.: US 2007/0199620 A1
(43) Pub. Date: Aug. 30, 2007

(54) ROUTER TABLE

(75) Inventor: Norston Fontaine, Minneapolis, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: BENCH DOG, INC., Minneapolis, MN (US)

(21) Appl. No.: 11/696,030

(22) Filed: Apr. 3, 2007

Related U.S. Application Data
(63) Continuation of application No. 11/323,448, filed on Dec. 30, 2005, now abandoned.
(60) Provisional application No. 60/640,915, filed on Dec. 30, 2004.

(51) Int. Cl. B25H 1/00

(52) U.S. Cl. 144/286.1

(57) ABSTRACT

Worktables for use with routers and other power tools are disclosed. A worktable in accordance with an exemplary embodiment of the present invention may include a cast iron router top having a top surface defining a flanged opening, a router insert plate adjustably mounted within the flanged opening, and a support structure adapted to support the router top. The worktable can be configured for use as a stand-alone router table, or in conjunction with one or more additional worktable top members such as a table saw, band saw, jointer, and power sander.

This application is a continuation of U.S. application Ser. No. 11/323,448, filed Dec. 30, 2005, which claims priority to U.S. Provisional Application Ser. No. 60/640,915 filed Dec. 30, 2004.

### FIELD

The present invention relates generally to the field of tools and accessories for cutting and shaping wood. More particularly, the present invention relates to configurable worktables for use with routers and other power tools.

### BACKGROUND

Router tables are utilized in woodworking applications to support a workpiece as it passes across a router bit. Typically, such devices include a top plate that can be used to support the router against the surface to be routed, a router motor having a rotatable drive shaft, and a router bit whose height can be adjusted above the surface of the top plate to provide a desired amount of cutting. Examples of applications that can be performed using such devices may include routing, grooving, fluting, jointing, shaping and beading. In certain applications, a guide mechanism such as a fence may be employed to guide the workpiece along the work surface. A guide bushing may also be placed within an opening of the top plate to guide the workpiece around the router bit for certain procedures such as template or inlay cutting.

### SUMMARY

The present invention relates to worktables for use with routers and other power tools. A worktable in accordance with an exemplary embodiment of the present invention may include a cast iron router top having a top surface defining a flanged opening, a router insert plate adjustably mounted within the flanged opening, and a support structure adapted to support the router top. The router top can be equipped with an adjustment mechanism for altering the height of the router insert plate relative to the top surface of the router top. In certain embodiments, for example, a number of leveling screws can be provided to precisely adjust the height of the router insert plate so that it lies flush with the top surface of the router top. An extension wing assembly can be provided to facilitate mounting of the router top to various other top plates supported by the structure. In some embodiments, the router top may further include a means for securing the router top to other adjacent members such as a table saw, blank top plate, and/or an end cap. Other features and accessories such as a fence, miter track, vacuum port, etc. may also be provided, as described herein.

The worktable can be configured for use as a stand-alone router table, or in conjunction with one or more other power tools such as a table saw, band saw, jointer, power sander, etc. In certain embodiments, for example, the router top may comprise a left extension of an existing table saw, allowing the user to perform both routing and sawing operations on the same worktable. The support structure may comprise a cabinet, stand, or other suitable means for supporting the router top and/or other top plates. In some embodiments, multiple such support structures can be linked together to permit other desired worktable configurations to be built.

### BRIEF DESCRIPTION OF THE DRAWINGS

FIG. 1 is a perspective view of an illustrative worktable in accordance with an exemplary embodiment of the present invention;

FIG. 2 is an enlarged view showing the first extension wing assembly of FIG. 1 in greater detail;

FIG. 3 is a partial cross-sectional view showing the connection of the first extension wing assembly to the router top of FIG. 1;

FIG. 4 is an assembly view showing the assembly of a router insert plate and miter track to the router top of FIG. 1;

FIG. 5 is a side cross-sectional view showing the connection of the router insert plate to the router top of FIG. 1;

FIG. 6 is a side cross-sectional view showing the connection of the miter track to the router top of FIG. 1;

FIG. 7 is an assembly view showing the attachment of the router top to the adjacent table saw top of FIG. 1;

FIG. 8 is a perspective view showing the connection of a rip fence to the worktable of FIG. 1;

FIG. 9 is a perspective view of an illustrative worktable in accordance with another exemplary embodiment of the present invention;

FIG. 10 is a perspective view of an illustrative worktable in accordance with another exemplary embodiment of the present invention;

FIG. 11 is a perspective view of an illustrative worktable in accordance with another exemplary embodiment of the present invention;

FIG. 12 is a perspective view of an illustrative worktable in accordance with another exemplary embodiment of the present invention; and

FIG. 13 is a perspective view of an illustrative worktable in accordance with an exemplary embodiment of the present invention employing multiple blank tops.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, materials and manufacturing processes are illustrated for the various elements, those skilled in the art will recognize that many of the examples provided have suitable alternatives that may be utilized.

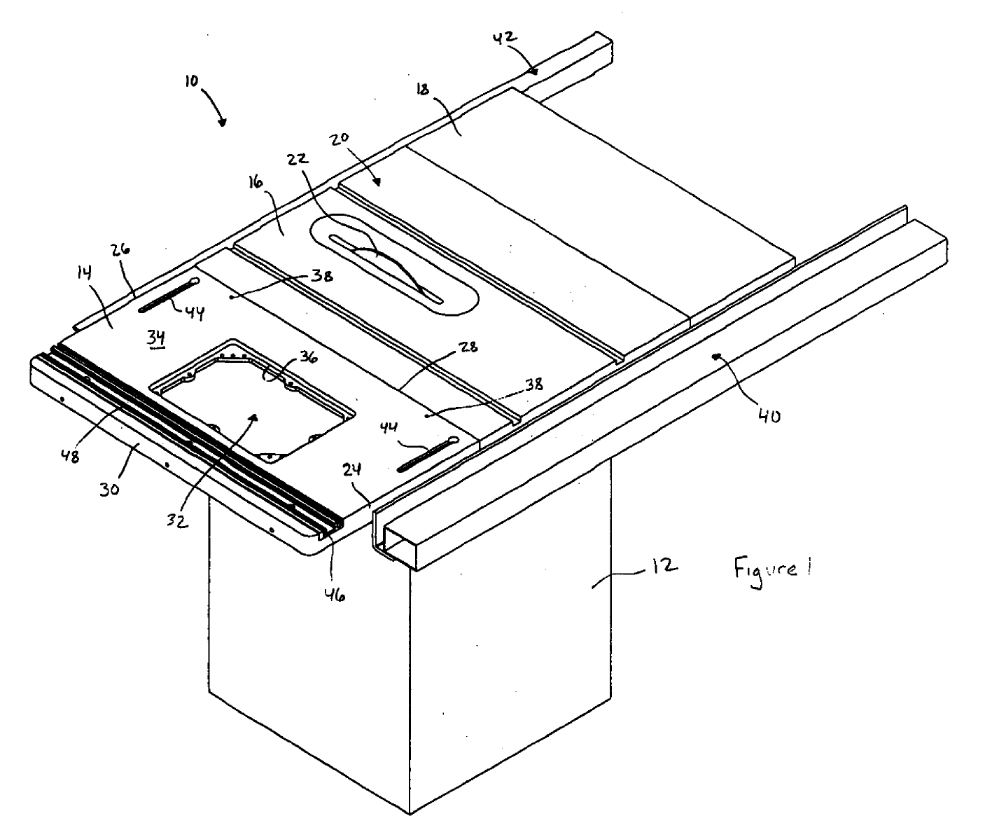

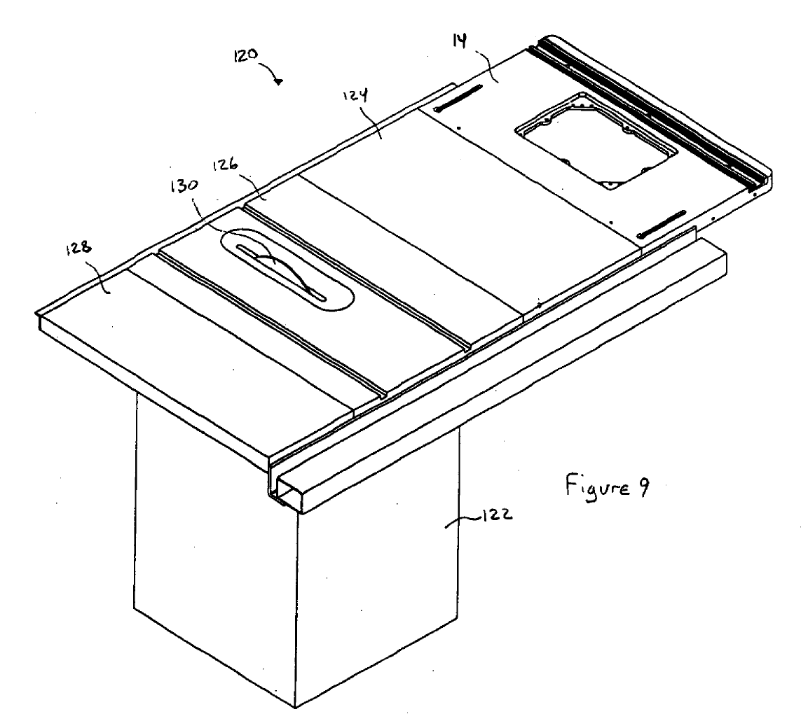

FIG. 1 is a perspective view of an illustrative worktable 10 in accordance with an exemplary embodiment of the present invention. Worktable 10, illustratively a combination router and table saw, may include a support structure 12 adapted to support thereon a number of detachable top plates that can be used to support a workpiece against a router, circular saw, band saw, jointer, power sander, and/or other desired power tool. In the illustrative embodiment of FIG. 1, for example, the support structure 12 may include a router top 14, a table saw top 16, and a blank top 18, which collectively form a top surface 20 of the worktable 10. As is further described below with respect to FIGS. 8-13, the router top 14 can be configured for use in any number of desired positions, either alone or in conjunction with other power tools supported by the support structure 12. Thus, while the illustrative embodiment of FIG. 1 shows a router top 14 configured for use as a left extension of a worktable 10 equipped with a table saw 22, other configurations are possible.

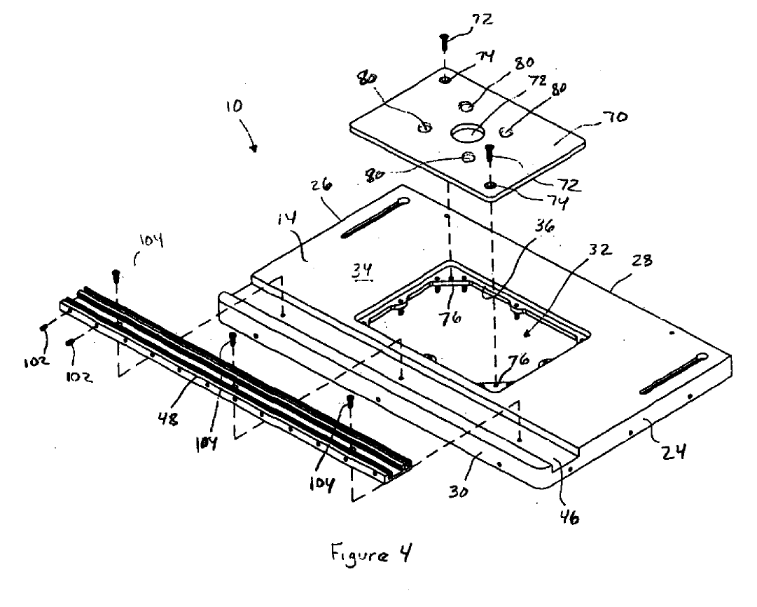

The router top 14 may include a first side 24, a second side 26, a first end 28, and a second end 30. An opening 32 disposed through the router top 14 permits a portion of the router bit (not shown) to protrude upwardly above a top surface 34 of the router top 14. The opening 32 may have a substantially rectangular shape with a countersunk flange 36 inset a distance below the top surface 34 of the router top 14. In use, the flange 36 can be coupled to a router insert plate (see FIG. 3) that supports the router at least in part within the opening 32. A number of countersunk holes 38 disposed within the top surface 34 of the router top 14 can be provided to secure the router top 14 to the support structure 12 with mounting bolts, if desired.

The worktable 10 can be further equipped with a first extension wing assembly 40 and/or a second extension wing assembly 42, which in the illustrative embodiment of FIG. 1 are each shown coupled to a portion of the router top 16, the saw top 18, and the blank top 20. A set of fence mounting slots 44 disposed within the top surface 34 of the router top 14 can be configured to receive a rip fence that can be used to guide the workpiece across the router top surface 34 as it passes through the router bit. In certain embodiments, a channel 46 inset within the top surface 34 of the router top 14 can be further configured to receive a guide track 48, allowing the user to attach a miter gauge, feather board, fence stop, table stop, starting pin, and/or other desired tool.

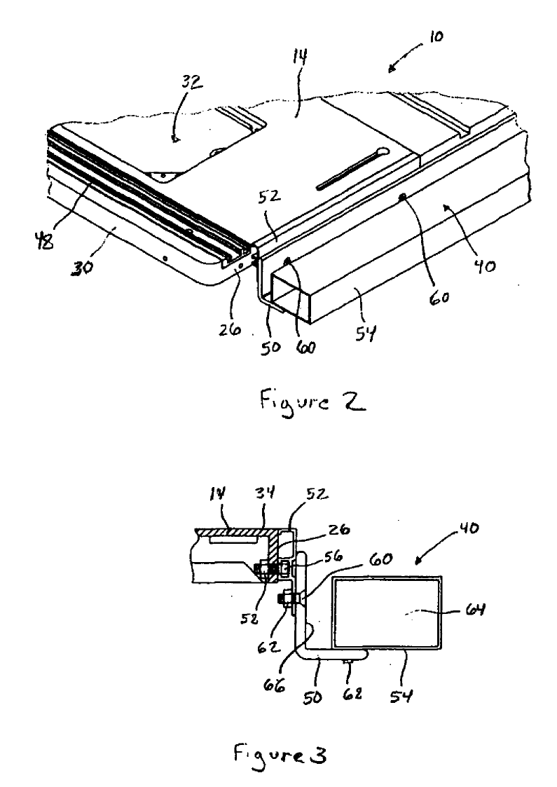

FIG. 2 is an enlarged view showing the first extension wing assembly 40 of FIG. 1 in greater detail. As can be seen in FIG. 2, the first extension wing assembly 40 may include an elongated L-shaped side rail 50, a mounting bracket 52, and a fence guide 54, each of which are oriented lengthwise in a direction along the width of the worktable 10 parallel to the first side 26 of the router top 14. A similar configuration can be provided for the second extension wing assembly 42, if desired.

The side rail 50 can be configured to provide support for the various top plates 16,18,20, and can be utilized to permit additional top plates to be added to the worktable 10, if desired. As can be further seen in FIG. 3, the side rail 50 can be fixedly secured to the left side 26 of the router top 14 using the mounting bracket 52, which can be mounted level with the top surface 34 of the router top 14 to prevent any overhang or gaps. The mounting bracket 52 can be secured to the left side 26 of the router top 14 using, for example, a bolt 56 and lock nut 58, although other fastening means are possible. A countersunk screw 60 and lock nut 62, in turn, can be provided to secure the side rail 50 to the mounting bracket 52.

As can be further seen in FIG. 3, the fence guide 54 may comprise a rectangular-shaped tube defining an interior section 64 that permits the length of the fence guide 54 to be lengthened or shortened using an optional extension member, if desired. The bolt 60 used in securing the side rail 50 to the mounting bracket 52 can be countersunk within a face 66 of the side rail 50, providing a greater amount of clearance between the side rail 50 and fence guide 54. The fence guide 54 can be secured to the side rail 50 using a screw 68 located on the underside of the fence guide 54. While a rectangular-shaped fence guide tube is specifically depicted in FIG. 3, it should be understood that other types of fence guides could be provided, as desired.

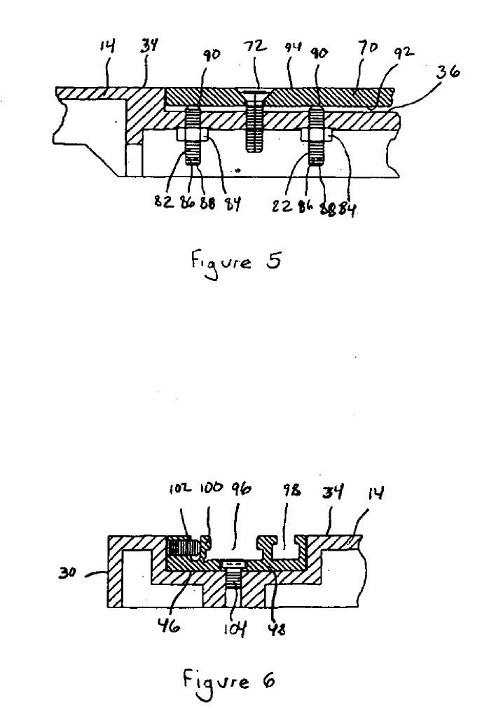

FIG. 4 is an assembly view showing the connection of an illustrative router insert plate 70 and the guide track 48 to the router top 14 of FIG. 1. As shown in FIG. 4, the router insert plate 70 may have a size and shape similar to opening 32, allowing the router insert plate 70 to lie flush against the flange 36. In one illustrative embodiment, for example, the router insert plate 70 may have a dimension of 8¼ inches by 11¾ inches, although other configurations are possible. The router insert plate 70 may be fabricated from a metal such as cast iron, steel, aluminum, nickel-plated brass, or alternatively a polymeric material such as acrylonitrile butadiene styrene (ABS), polypropylene (PP), polyvinylchloride (PVC), or nylon. In certain embodiments, the router top inset plate 70 may be formed from a thermoplastic resin such as acrylic or phenol.

A set of mounting screws 72 can be provided at the two comers of the router insert plate 70 to secure the plate 70 to the router top 14. The mounting screws 72 can be inserted through a number of through holes 74 in the router insert plate 70 and threadably engaged within a number of openings 76 in the flange 36. In use, the mounting screws 72 prevent side-to-side movement and excessive vibration in the router insert plate 70 that can adversely affect routing performance.

An opening 78 disposed through the router insert plate 70 can be sized to permit the router bit to extend upwardly above the top surface 34 of the router top 14. The router bit opening 78 may have a diameter of about 2 inches, which is sufficient in size to accept many conventional router bits. The opening 78, however, may have a diameter larger or smaller than this value to allow other types of bits to be used. In some embodiments, a number of pre-drilled mounting holes 80 can be further provided to facilitate attachment of the router insert plate 70 to the router. The number and location of the mounting holes 80 may vary depending on the particular type of router to be mounted.

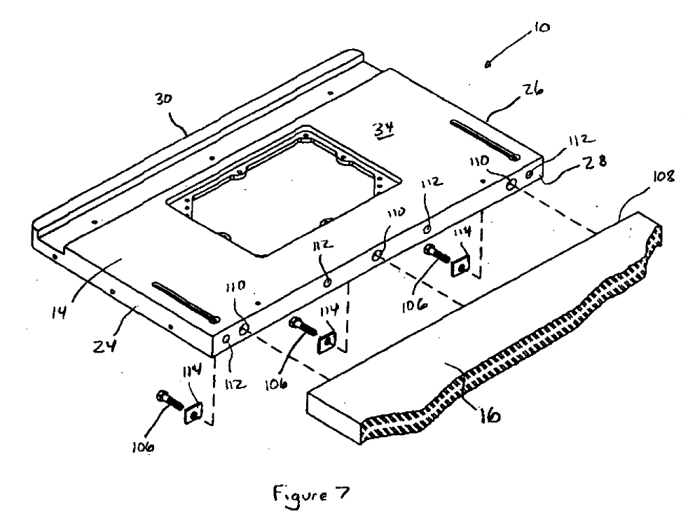

FIG. 5 is a side cross-sectional view showing the connection of the router insert plate 70 to the router top 14. As can be seen in FIG. 5, a number of adjustable leveling screws 82 threadably disposed within several openings in the flange 36 can be utilized to adjust the height and/or leveling of the router insert plate 70. A lock nut 84 provided on each leveling screw 82 can be engaged against the underside of the flange 36 to tighten the leveling screws 82 to the flange 36.

Each leveling screw 82 may include a slot 86 at one end 88 that can be used to rotate the leveling screw 82 in either a clockwise or counter-clockwise direction. Such rotation of the leveling screw 82 via the slot 86 causes an adjustment in the height of the opposite end 90 of the leveling screw 82, which supports the bottom surface 92 of the router insert plate 70. By adjusting the height of the leveling screws 82, the top surface 94 of the router insert plate 70 can be precisely leveled and made flush with the top surface 34 of the router top 14 to prevent the existence of any gaps that can impede smooth transitioning of the workpiece across the work surface. In some applications, the use of adjustable leveling screws 82 may also permit router insert plates of varying thickness to be mounted to the router top 14, if desired.

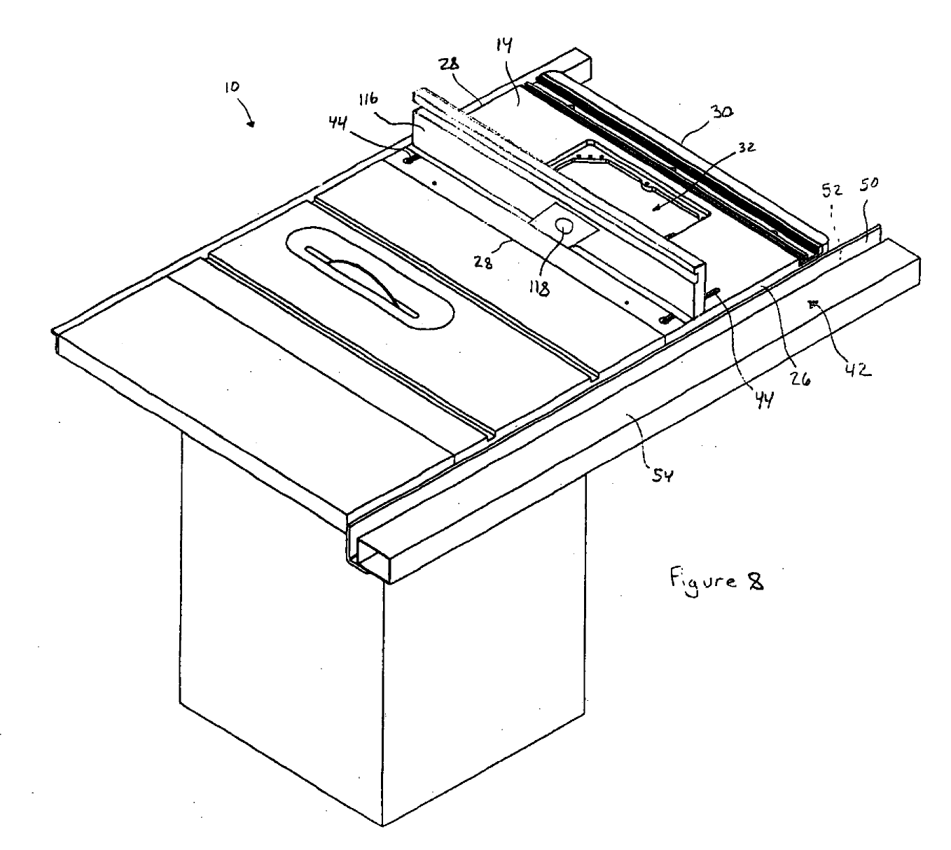

FIG. 6 is a side cross-sectional showing the connection of the miter track 48 to the router top 14. As shown in FIG. 6, the miter track 48 may include a main T-shaped slot 96 adapted to receive a miter gauge, and a secondary T-shaped slot 98 adapted to receive various other accessories such as a feather board, fence stop, table stop, and/or starting pin. The main slot 96 may be dimensioned slightly larger than the secondary slot 98, having a dimension of about ⅜ inches by ¾ inches. The dimensions of the main slot 96 and/or the secondary slot 98 may vary, however, for use with other tools and accessories, as desired.

A bendable gib 100 located along the front wall of the miter track 48 can be configured to displace slightly to facilitate insertion and/or removal of the miter gauge within the main slot 96. Bending of the gib 100 may be accomplished, for example, by squeezing the gib 100 against the front wall of the miter track 48 with a pair of channel locks. A set screw 102 disposed through the front wall of the miter track 48 can be utilized to engage the gib 100 against the miter gauge once inserted within the main slot 96. A number of mounting bolts 104 can be utilized to secure the miter track 48 to the channel 46 of the router top 14, if desired.

FIG. 7 is an assembly view showing the attachment of the router top 14 to the adjacent table saw top 16 of FIG. 1. As shown in FIG. 7, each end 28,30 of the router top 14 may include a number of mounting bolts 106 that can be threadably engaged within a number of openings disposed within the adjacent end 108 of the saw top 16. Each mounting bolt 106 can be received within three oversized holes 110 formed through each end 28,30 of the router top 14, allowing for connection to adjacent members employing a three-hole mounting pattern. A second set of four holes 112 formed through each end 28,30 of the router top 14 can be further provided for attachment to adjacent members employing a four-hole mounting pattern, if desired. In either the three or four-hole mounting configurations, a number of heavy rectangular washes 114 can be provided for use with one or more of the openings 110,112 to permit the mounting bolts 106 to be attached to adjacent members having holes that are offset slightly, if necessary.

FIG. 8 is a perspective view showing the connection of a rip fence 116 to the worktable 10 of FIG. 1. As shown in FIG. 8, the rip fence 116 can be attached to the router top 14 using the fence mounting slots 44, which allow the rip fence 116 to be adjusted relative to the opening 32. Attachment of the rip fence 116 to the router top 14 may be accomplished, for example, using a set of T-knobs each threadably connected to a corresponding bolt located underneath the router top 14. A built-in vacuum dust port 118 connected to the rear side of the rip fence 116 can be coupled to a vacuum hose (not shown) for connection to a dust collection system. Other features such as a dual position bit guard, adjustably sliding sub fences, front and back T-slots, and built-in jointing settings may also be provided on the rip fence 116, if desired.

As can be further seen in FIG. 8, the router top 14 can be further configured for use as a second (i.e. right) extension of the worktable 10, having a second extension wing assembly 42 equipped with an L-shaped side rail 50, mounting bracket 52 (hidden), and fence guide 54, similar to that described above with respect to the first wing assembly 40 of FIG. 1. In the illustrative embodiment of FIG. 8, however, the second extension wing assembly 42 extends beyond the end 30 of the router top 14 a short distance such that the fence guide 54 spans the entire length of the router top side 26.

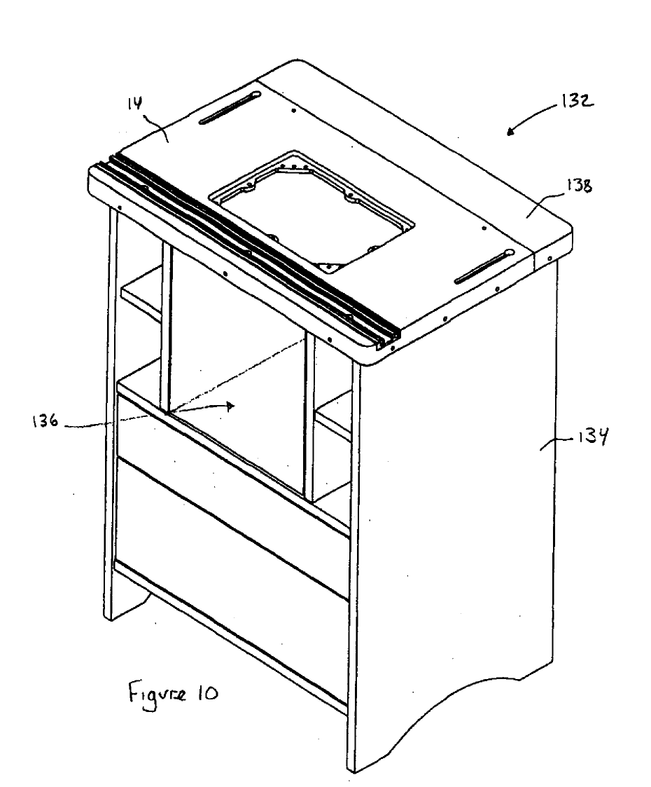

While the illustrative embodiment of FIG. 1 shows the attachment of the router top 14 immediately adjacent to a table saw top 16, it should be understood that the router top 14 could be utilized in any number of desired configurations, either alone or in conjunction with one or more additional worktable top members such as a table saw, band saw, jointer, and/or power sander. In one such alternative worktable 120 depicted in FIG. 9, for example, the illustrative router top 14 may be mounted to a support structure 122 including a blank top 124, a table saw top 126, and an end cap 128. The blank top 124 may be interposed between the router top 14 and the table saw top 126, thus providing a greater amount of table surface between the saw blade 130 and the router top 14. The end cap 128, in turn, may be located adjacent the side of the table saw top 126 located opposite the blank top 124, thus providing a greater amount of table surface to the left of the saw blade 130.

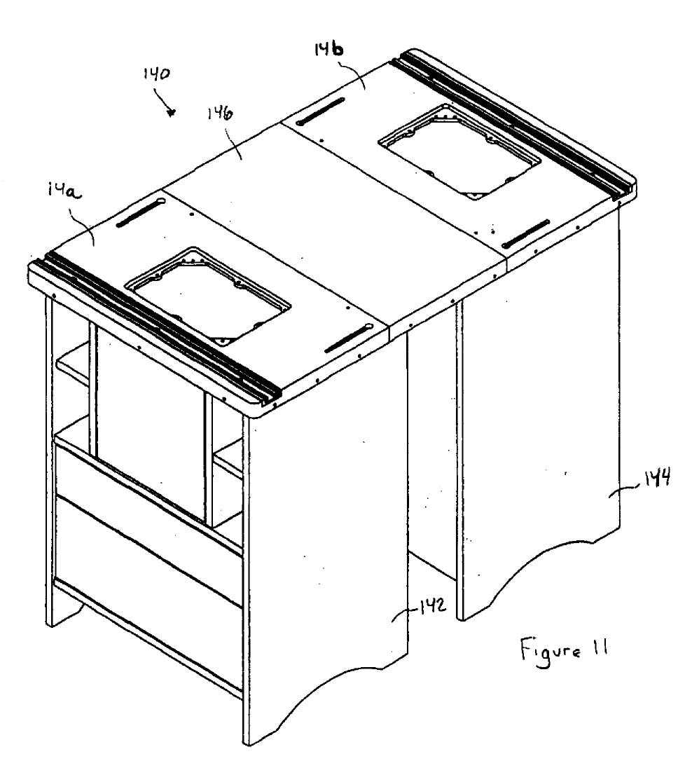

FIG. 10 is a perspective view of an illustrative worktable 132 in accordance with another exemplary embodiment of the present invention, wherein the worktable 132 comprises a stand-alone router table. As shown in FIG. 10, the router top 14 can be configured to mount to a cabinet 134, allowing the user to store various tools and supplies while also conserving space. An opening 136 disposed within the interior of the cabinet 134 can be adapted to receive the router (not shown) located below the surface of the router top 14. In certain embodiments, and as further depicted in FIG. 10, a cast iron end cap 138 can be connected to the router top 14 and cabinet 134 to increase the amount of table surface available and to provide a more finished look, if desired.

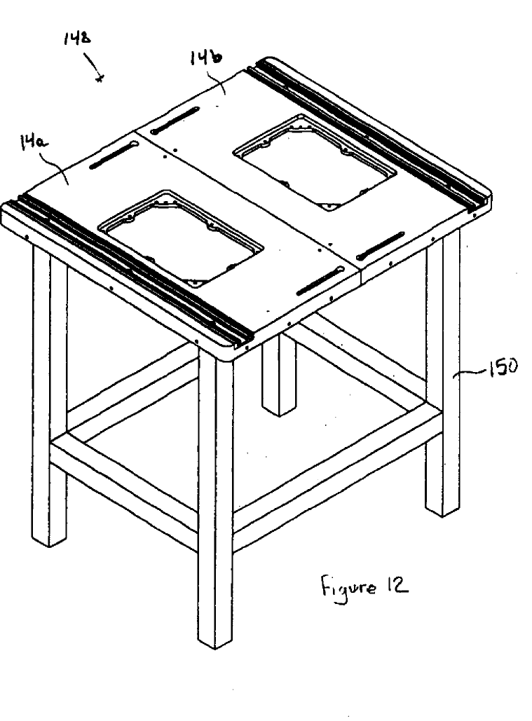

FIG. 11 is a perspective view of an illustrative worktable 140 in accordance with another exemplary embodiment of the present invention, wherein the worktable 140 includes two router tops 14a,14b. As shown in FIG. 11, each router top 14a,14b can be mounted to a separate cabinet 142,144, which, in turn, can be connected together using a blank top 146 in a manner similar to that discussed above with respect to FIG. 7. The router tops 14a,14b can be arranged back-to-back with each other, allowing the user to make a first pass of a workpiece across the first router top 14a and then transfer the workpiece to the other router top 14b for performing a second routing operation. While the router tops 14a,14b depicted in FIG. 11 are shown arranged in a back-to-back configuration, it should be understood that the router tops 14a,14b could also be arranged back-to-front with each other. As with other embodiments herein, an end cap or other such top member can be further provided on the worktable 140, if desired.

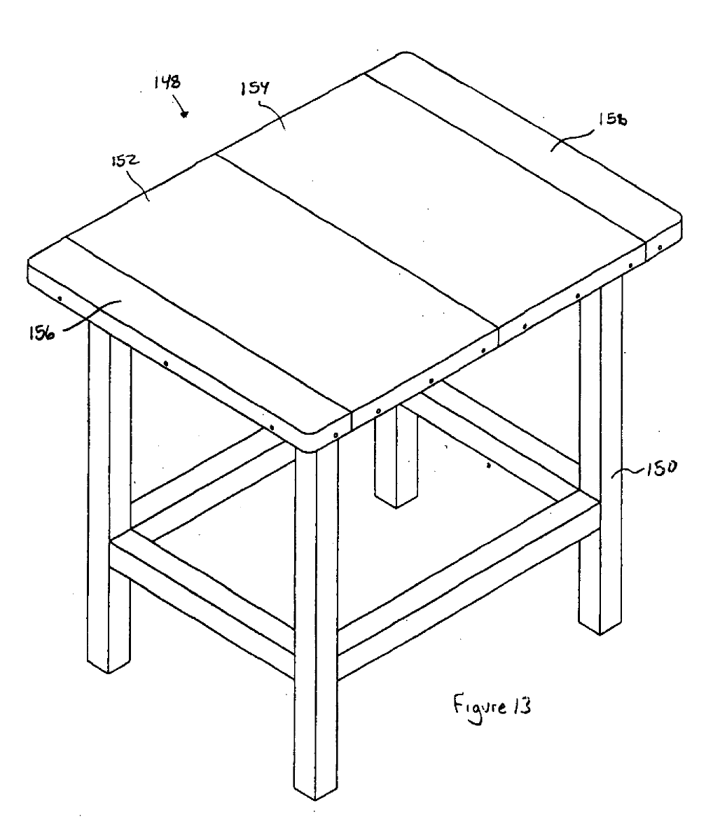

FIG. 12 is a perspective view of an illustrative worktable 148 in accordance with another exemplary embodiment of the present invention, wherein the worktable 148 includes two router tops 14a,14b disposed on a single support stand 150. As shown in FIG. 12, each of the router tops 14a,14b can be mounted to the support stand 150 back-to-back with each other, allowing the user to perform multiple router operations thereon. In certain embodiments, the support stand 150 may comprise an existing convertible utility stand for use in supporting other power tools such as a table saw, band saw, jointer, power sander, etc. The router tops 14a,14b can each be removed to permit other top members (e.g. blank tops, table saw tops, etc.) to be mounted to the support stand 150. As can be seen, for example, in FIG. 13, the two router tops 14a,14b can be removed from the support stand 150 and replaced with one or more blank tops 152,154 and/or end caps 156,158. Other configurations are, however, possible.

Having thus described the several embodiments of the present invention, those of skill in the art will readily appreciate that other embodiments may be made and used which fall within the scope of the claims attached hereto. Numerous advantages of the invention covered by this document have been set forth in the foregoing description. It will be understood that this disclosure is, in many respects, only illustrative. Changes may be made in details, particularly in matters of shape, size and arrangement of parts without exceeding the scope of the invention.

What is claimed is:

1. A worktable for use with a router, comprising:
a cast iron router top having a top surface defining a flanged opening;
a router insert plate adjustably mounted within the flanged opening; and
a support structure adapted to support the router top.

2. The worktable of claim 1, further comprising means for adjusting the height of the router insert plate relative to the top surface of the router top.

3. The worktable of claim 2, wherein said means for adjusting the height of the router insert plate relative to the top surface of the router top includes a number of leveling screws.

4. The worktable of claim 1, wherein the support structure is further configured to support one or more additional worktable top members.

5. The worktable of claim 1, wherein the worktable further includes an extension wing assembly.

6. The worktable of claim 5, wherein said extension wing assembly includes an elongated L-shaped side rail, a mounting bracket, and a fence guide.

7. The worktable of claim 1, wherein the router top further includes a number of fence mounting slots.

8. The worktable of claim 7, further comprising a fence mounted to the fence mounting slots.

9. The worktable of claim 1, further comprising an adjustable miter track mounted to the top surface of the router top.

10. The worktable of claim 9, wherein the adjustable miter track includes a first elongated T-shaped slot adapted to receive a miter gauge and a second T-shaped slot adapted to receive one or more other tools therein.

11. The worktable of claim 1, further comprising means for securing the router top to one or more additional worktable top members.

12. The worktable of claim 11, wherein said means for securing the router top to one or more additional worktable top members includes at least one mounting bolt and a heavy rectangular washer.

13. The worktable of claim 12, wherein each mounting bolt is adapted to fit through an oversized bolt hole within the router top.

14. The worktable of claim 1, wherein said support structure is a cabinet.

15. The worktable of claim 1, wherein said support structure is a support stand.

16. The worktable of claim 1, wherein said worktable is a router table.

17. The worktable of claim 1, wherein said worktable is a table saw.
